(19) United States
(12) Patent Application Publication
(10) Pub. No.: US 2021/0394297 A1
(43) Pub. Date: Dec. 23, 2021

(54) RESISTANCE WELDING DEVICE, HOLLOW ARM, AND METHOD OF MANUFACTURING HOLLOW ARM

(71) Applicant: HONDA MOTOR CO., LTD., Minato-ku, Tokyo (JP)

(72) Inventors: Yohei Teragaito, Haga-gun, Tochigi-ken (JP); Yoshito Otake, Haga-gun, Tochigi-ken (JP); Takuya Furuno, Haga-gun, Tochigi-ken (JP); Takuya Hino, Haga-gun, Tochigi-ken (JP); Noriyoshi Miyaoka, Haga-gun, Tochigi-ken (JP)

(21) Appl. No.: 17/279,114

(22) PCT Filed: Sep. 17, 2019
(86) PCT No.: PCT/JP2019/036371

§ 371 Date: Mar. 24, 2021

(30) Foreign Application Priority Data
Sep. 27, 2018 (JP) 2018-181610

(51) Int. Cl. B23K 11/11; B23K 20/12; B25J 18/00

(52) U.S. Cl. CPC B23K 11/11; B23K 37/02; B25J 18/00; B23K 20/12

(57) ABSTRACT

The present invention relates to a resistance welding device, a hollow arm, and a method of manufacturing a hollow arm. A welding gun is provided with the hollow arm for holding a movable electrode. The hollow arm includes an arm body having a cavity portion that is opened on one side, and a cover attached to an opening end surface of the arm body so as to cover an opening of the cavity portion. The arm body and the cover are secured by a friction stir welding portion extending along a peripheral part of the cover.

### TECHNICAL FIELD

The present invention relates to a resistance welding device for welding a workpiece by electrifying the workpiece via an electrode, relates to a hollow arm for holding an article, and relates to a method of manufacturing the hollow arm.

### BACKGROUND ART

Japanese Laid-Open Patent Publication No. 2016-132031 discloses a welding gun (a resistance welding device) comprising a hollow arm that holds an electrode.

The hollow arm described in Japanese Laid-Open Patent Publication No. 2016-132031 includes: an arm main body having a recess that opens on one side; and a cover attached to an opening end surface of the arm main body so as to cover an opening of the recess.

### SUMMARY OF INVENTION

The hollow arm described in Japanese Laid-Open Patent Publication No. 2016-132031 has suffered from a problem that, since the arm main body and the cover are fastened by a large number of fastening members (for example, bolts) in order to secure rigidity, there is a resulting increase in weight.

The present invention, which was made in view of such a problem, has an object of providing a hollow arm which is light-weight and of high rigidity, a resistance welding device comprising the hollow arm, and a method of manufacturing the hollow arm.

A first aspect of the present invention is a resistance welding device that welds a workpiece by electrifying the workpiece via an electrode, the resistance welding device comprising a hollow arm configured to hold the electrode, the hollow arm including: an arm main body including a cavity portion that opens at least on one side; and a cover attached to an opening end surface of the arm main body so as to cover an opening of the cavity portion, and the arm main body and the cover being fixed by a friction stir welding portion extending along a peripheral edge portion of the cover.

A second aspect of the present invention is a hollow arm that holds an article, the hollow arm comprising: an arm main body including a cavity portion that opens at least on one side; and a cover attached to an opening end surface of the arm main body so as to cover an opening of the cavity portion, the arm main body and the cover being fixed by a friction stir welding portion extending along a peripheral edge portion of the cover.

A third aspect of the present invention is a method of manufacturing a hollow arm that holds an article, the method comprising: a step of providing a main body member made of a metal and including a cavity portion that opens at least on one side, the main body member being an arm main body including the cavity portion or being a material prior to being molded in a shape of the arm main body; a step of providing a cover including a peripheral edge portion that follows an outer peripheral shape of the arm main body; a step of attaching the cover to the main body member in a manner that the cover covers an opening of the cavity portion; and a step of friction stir welding the main body member and the cover.

In the present invention, the arm main body and the cover are fixed by the friction stir welding portion extending along the peripheral edge portion of the cover. This makes it possible to provide a hollow arm which is light-weight and of high rigidity, a resistance welding device comprising the hollow arm, and a method of manufacturing the hollow arm.

### BRIEF DESCRIPTION OF DRAWINGS

FIG. 1 is a side view showing an overall configuration of a welding gun according to the present embodiment;

FIG. 2 is a perspective view of a hollow arm of the welding gun;

FIG. 3 is a cross-sectional view of the hollow arm taken along the line III-III in FIG. 2;

FIGS. 4A, 4B, and 4C are step diagrams for explaining a method of manufacturing the hollow arm;

FIGS. 5A, 5B, 5C, 5D, 5E, and 5F are step-by-step cross-sectional views for explaining the method of manufacturing the hollow arm; and

FIGS. 6A, 6B, and 6C are respectively a cross-sectional view of a hollow arm of modified example 1, a cross-sectional view of a hollow arm of modified example 2, and a cross-sectional view of a hollow arm of modified example 3.

### DESCRIPTION OF EMBODIMENTS

A preferred embodiment of a resistance welding device, a hollow arm, and a method of manufacturing the hollow arm according to the present invention will be presented and described in detail below with reference to the accompanying drawings.

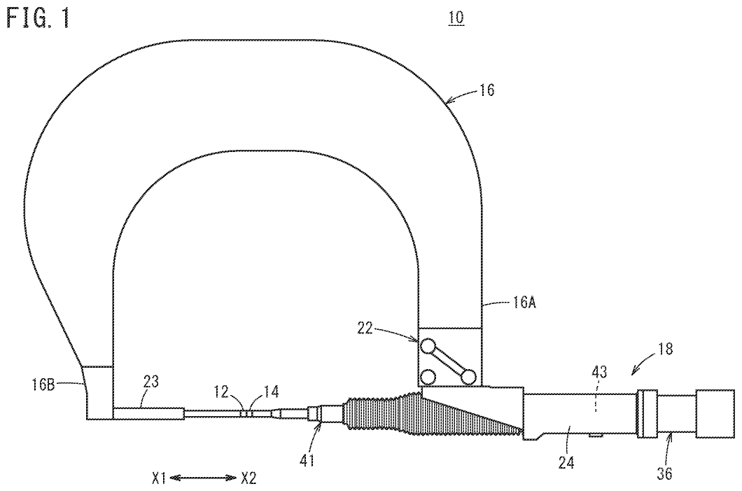

FIG. 1 is a side view showing an overall configuration of a welding gun (a resistance welding device) 10. The welding gun 10 is a resistance welding device that welds a workpiece by electrifying the workpiece via an electrode. Specifically, the welding gun 10 is a resistance welding device that performs spot joining of a workpiece configured by a plurality of overlaid plate materials, by sandwiching/pressurizing the workpiece by a fixed electrode 12 and a movable electrode 14, and passing a welding current between the fixed electrode 12 and the movable electrode 14.

The welding gun 10 is employed in a welding robot, for example. That is, the welding gun 10 is gripped by the welding robot, for example. As shown in FIG. 1, the welding gun 10 includes, in addition to the fixed electrode 12 and the movable electrode 14, a hollow arm 16 that holds the fixed electrode 12, and an electrode moving mechanism 18 that advances/retracts the movable electrode 14. In detail, the electrode moving mechanism 18 moves the movable electrode 14 in an X axis direction being one axial direction that includes a direction of approaching the fixed electrode 12 (an X1 direction) and a direction of separating from the fixed electrode 12 (an X2 direction). That is, an advancing/retracting direction of the movable electrode 14 is the X axis direction.

As shown in FIG. 1, the hollow arm 16 has a substantially U-like shape in side view, and has one end 16A of the U-like shape attached to a later-mentioned housing 24 via an attaching portion 22. Another end 16B of the U-like shape of the hollow arm 16 is provided with a long and narrow electrode attaching member 23 that extends in the X2 direction from the other end 16B. The fixed electrode 12 is fixed to an end portion of the electrode attaching member 23 on an X2 side.

The electrode moving mechanism 18 has: a holding portion 41 that holds the movable electrode 14; and a moving mechanism portion 43 that moves the holding portion 41 in the X axis direction and includes, for example, a ball screw mechanism. The holding portion 41 holds the movable electrode 14 in such a manner that the movable electrode 14 faces the fixed electrode 12 in the X axis direction. The moving mechanism portion 43 is housed in the housing 24. The housing 24 functions also as a gripping portion to be gripped by the welding robot. The electrode moving mechanism 18 further has a motor 36 that drives the moving mechanism portion 43 to cause an advancing/retracting operation to be performed on the movable electrode 14.

The hollow arm 16 will be described in more detail below.

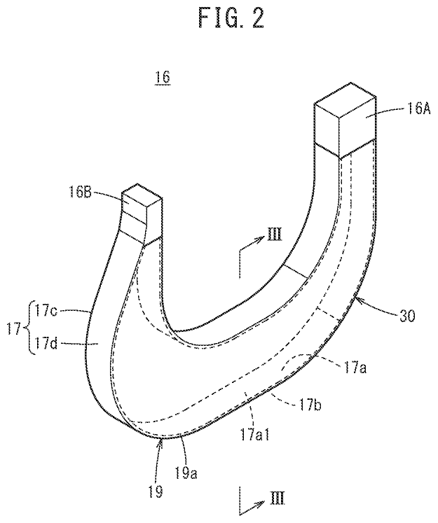

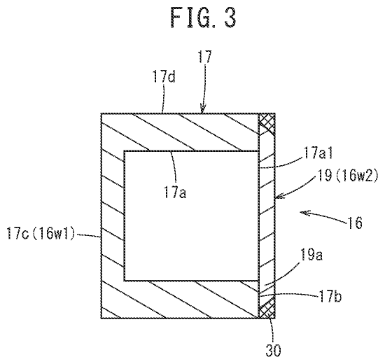

As shown in FIGS. 2 and 3, the hollow arm 16 has: an arm main body 17 having a cavity portion 17a that opens on one side; and a cover 19 attached to an opening end surface 17b of the arm main body 17 so as to cover an opening 17a1 of the cavity portion 17a.

The arm main body 17 has: a base plate portion 17c that configures a first side wall 16w1, which is one of the first side wall 16w1 and a second side wall 16w2 of the hollow arm 16 that face each other; and a peripheral wall plate portion 17d that projects in a thickness direction of the base plate portion 17c from a peripheral edge portion of the base plate portion 17c, and extends along the peripheral edge portion of the base plate portion 17c. That is, the arm main body 17 has a substantially U-like cross-sectional shape.

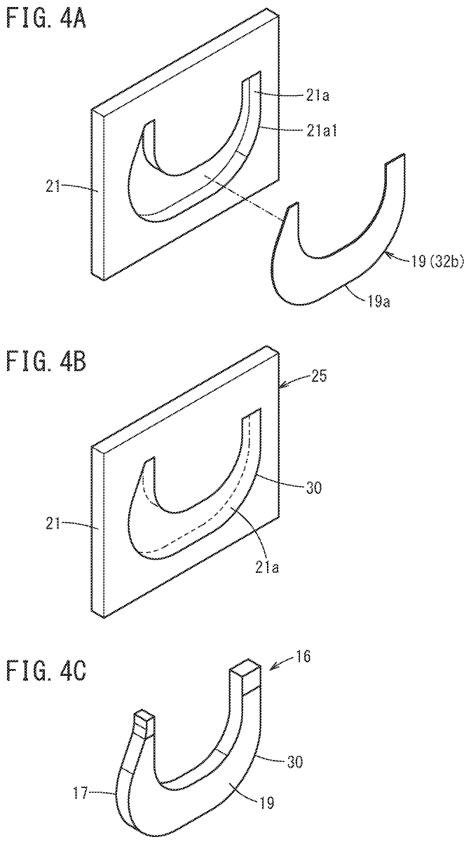

The cover 19 configures the second side wall 16w2 of the hollow arm 16. Describing this in detail, the cover 19 is configured from a plate-like member having a peripheral edge portion 19a that follows an outer peripheral shape of the arm main body 17 (refer to FIG. 4A).

A metal or the like may be cited as a material of the arm main body 17 and the cover 19. Here, the arm main body 17 and the cover 19 are configured made of aluminum, for example.

As shown in FIG. 2, the arm main body 17 and the cover 19 are fixed by a friction stir welding portion 30 extending along the peripheral edge portion 19a of the cover 19.

Describing this in detail, as shown in FIG. 3, the opening end surface 17b of the arm main body 17 and the peripheral edge portion 19a of the cover 19 are fixed by the friction stir welding portion 30 (the region illustrated by cross-hatching in FIG. 3).

In more detail, the opening end surface 17b of the arm main body 17 and the peripheral edge portion 19a of the cover 19 are fixed by the friction stir welding portion 30 over an entire periphery. Note that the opening end surface 17b of the arm main body 17 and the peripheral edge portion 19a of the cover 19 may be partially fixed by the friction stir welding portion 30, without being limited to being fixed thereby over the entire periphery. Hence, for example, there may be a place in part of the entire periphery lying along the peripheral edge portion 19a of the cover 19 where the opening end surface 17b of the arm main body 17 and the peripheral edge portion 19a of the cover 19 are not fixed by the friction stir welding portion 30. Alternatively, the opening end surface 17b of the arm main body 17 and the peripheral edge portion 19a of the cover 19 may be fixed by the friction stir welding portion 30 at a plurality of places separated along the peripheral edge portion 19a of the cover 19. The percentage of an extension length of the friction stir welding portion 30 (in the case of there being a plurality of friction stir welding portions 30, a length totaling the plurality of their lengths) with respect to a length of the entire periphery lying along the peripheral edge portion 19a of the cover 19 is set to 60% or more, and is preferably set to 80% or more, for example.

Note that configurations of the arm main body 17 and the cover 19 are not limited to the above-described configurations, and may be appropriately altered. A cross-sectional shape of at least one of the arm main body 17 and the cover 19 may be configured to be substantially L-like, or the cross-sectional shape of the cover 19 may be configured to be substantially U-like, for example. Moreover, although the hollow arm 16 is configured to be substantially U-like in side view, it may be of another shape (for example, substantially L-like, linear, and so on, in side view).

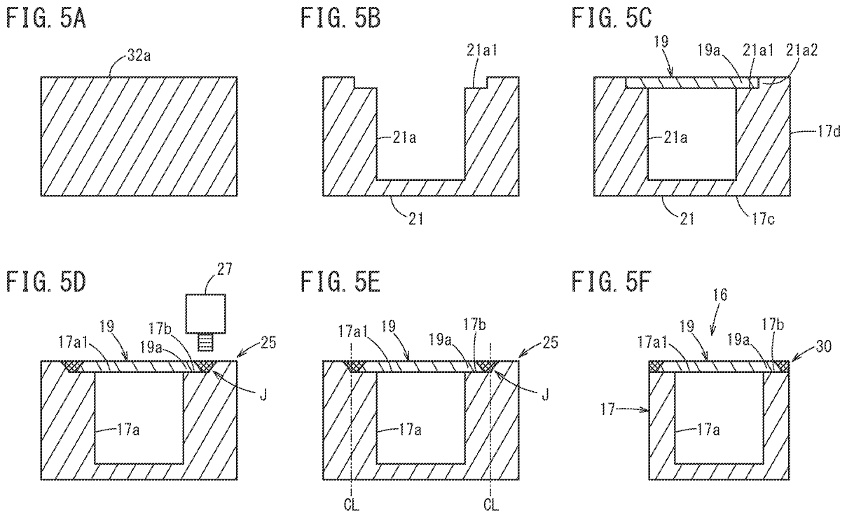

Next, an example of the method of manufacturing the hollow arm 16 will be described using FIGS. 4A to 4C, and 5A to 5F. FIGS. 4A to 4C are step diagrams showing manufacturing steps of the hollow arm 16. FIGS. 5A to 5F are step diagrams showing in cross section the manufacturing steps of the hollow arm 16. The hollow arm 16 is manufactured appropriately using a machine tool and other tools by a worker, for example.

First, as shown in FIG. 4A, there is provided a main body member 21 which is made of a metal and has a cavity portion 21a (here, a recess) that opens on one side, and there is provided the cover 19 having the peripheral edge portion 19a that follows the outer peripheral shape of the arm main body 17 (refer to FIG. 4C). Here, the main body member 21 is a material prior to being molded in a shape of the arm main body 17. In this case, the main body member 21 is manufactured from a first metal plate 32a shown in FIG. 5A. Specifically, the main body member 21 is manufactured by forming a stepped recess as the cavity portion 21a (hereafter, also written as stepped recess 21a) shown in FIGS. 4B and 5B on one side surface of the first metal plate 32a. The main body member 21 is manufactured by step boring processing, for example.

In FIG. 4A, the cover 19 is configured from a second metal plate 32b. The cover 19 is manufactured by processing a material (a metal plate), which is the second metal plate 32b prior to being molded in a shape of the cover 19, into a shape that fits in the stepped recess 21a. The cover 19 is manufactured by cutting processing, for example.

Next, as shown in FIG. 5C, the cover 19 is attached to the arm main body 17 so as to cover an opening of the cavity portion 21a of the main body member 21. Specifically, the peripheral edge portion 19a of the cover 19 is inserted in a step 21a1 of the stepped recess 21a of the main body member 21, whereby the cover 19 is fitted in the stepped recess 21a. Here, the peripheral edge portion 19a of the cover 19 is placed on the step 21a1.

Next, the main body member 21 and the cover 19 are friction stir welded. Specifically, as shown in FIGS. 5C and 5D, a friction stir tool 27 is employed to friction stir weld the peripheral edge portion 19a of the cover 19 and a peripheral portion 21a2 of the step 21a1 of the main body member 21. Describing this in detail, first, a portion of the main body member 21 other than a portion that is to become the arm main body 17 is fixed by a fixture. Then, a vicinity of a boundary of the peripheral edge portion 19a of the cover 19 that has been placed on the step 21a1 and the peripheral portion 21a2 of the step 21a1 undergoes friction stir welding by being pressed by the friction stir tool 27 from above. Such friction stir welding is performed over an entire periphery of the peripheral edge portion 19a of the cover 19 and the peripheral portion 21a2 of the main body member 21. As a result, as shown in FIG. 5E, a joined body 25 of the cover 19 and the main body member 21 that have been joined is obtained. Due to the friction stir welding, the stepped recess 21a becomes the cavity portion 17a.

Next, as shown in FIGS. 4C and 5F, the joined body 25 of the cover 19 and the main body member 21 that have been joined is processed into the shape of the hollow arm 16. Specifically, as shown in FIG. 5E, a portion further to the outside than a center of a joining portion J that has been friction stir welded in the joined body 25 (a portion further to the outside than the boundary of the peripheral edge portion 19a of the cover 19 and the peripheral portion 21a2 of the step 21a1, in the joining portion J (refer to FIG. 5C)) is removed as an unnecessary portion. That is, the joined body 25 is cut along a cutting line CL. Here, the cutting line CL is configured to run through a place that has been the peripheral portion 21a2 of the step 21a1 (refer to FIG. 5C) in the joining portion J. Therefore, part of the place that has been the peripheral portion 21a2 of the step 21a1, of the joining portion J, is removed. Note that cutting may be performed so as to leave the whole of the joining portion J.

By the above-described series of steps, the hollow arm 16, in which the arm main body 17 and the cover 19 are fixed over their entire periphery by the friction stir welding portion 30, is obtained as shown in FIGS. 4C and 5F.

Note that although here, the material prior to being molded in the shape of the arm main body 17 has been employed as the main body member 21, the main body member 21 may be configured as the arm main body 17. That is, a configuration may be adopted whereby, for example, the first metal plate 32a is processed into the shape of the arm main body 17 to manufacture the arm main body 17, and the cover 19 is attached to the arm main body 17.

Next, operation of the welding gun 10 configured as above will be described.

The welding robot performs welding of the workpiece configured by the plurality of overlaid plate materials by gripping by a movable arm the housing 24 being the gripping portion of the welding gun 10. Specifically, the welding robot moves the welding gun 10 so that the workpiece is positioned between the movable electrode 14 and the fixed electrode 12 that have been separated from each other (in detail, so that the workpiece is positioned in a vicinity of the fixed electrode 12), by the movable arm. The welding robot drives the motor 36 to bring the movable electrode 14 close to the fixed electrode 12, and thereby sandwiches/pressurizes the workpiece by the fixed electrode 12 and the movable electrode 14. The welding robot performs spot joining of the workpiece by passing a welding current between the fixed electrode 12 and the movable electrode 14. In order that, when spot joining of one workpiece finishes, spot joining of another workpiece is performed, the welding robot moves the welding gun 10 similarly to as described above. That is, in order for the welding robot to sequentially weld a plurality of workpieces, it moves the welding gun 10 between the workpieces.

Next, advantages of the welding gun 10 configured as above will be described.

As shown in FIG. 1, the welding gun 10 comprises the hollow arm 16 that holds the movable electrode 14. As shown in FIG. 2, the hollow arm 16 includes: the arm main body 17 having the cavity portion 17a that opens on one side; and the cover 19 attached to the opening end surface 17b of the arm main body 17 so as to cover the opening 17a1 of the cavity portion 17a. Here, the cavity portion 17a is a recess opening on one side in the thickness direction of the hollow arm 16. The arm main body 17 and the cover 19 are fixed by the friction stir welding portion 30 extending along the peripheral edge portion 19a of the cover 19.

Thus, the arm main body 17 and the cover 19 can be joined with high strength, without a fastening member such as a bolt being employed. As a result, the welding gun 10 comprising the light-weight and highly rigid hollow arm 16 can be realized.

In the case where an arm main body and a cover configuring a hollow arm of a welding gun are joined using a large number of fastening members, such as bolts, as in conventional technology (for example, Japanese Laid-Open Patent Publication No. 2016-132031), the welding gun itself ends up increasing in weight.

Since the hollow arm 16 is more light-weight compared to a conventional hollow arm, the welding gun 10 itself is made light-weight. In other words, the welding gun 10 excels in movement operability due to its inertial weight being small. In addition, since the hollow arm 16 of the welding gun 10 is of high rigidity, the welding gun 10 can stably hold the fixed electrode 12 so as to face (directly oppose) the movable electrode 14.

In conventional technology (for example, Japanese Laid-Open Patent Publication No. 2016-132031), fastening members are employed as mentioned above, hence a plurality of tap holes need to be formed in the arm main body, strength of the arm main body lowers, and it is difficult for the arm main body to be thinned (weight-lightened).

In the hollow arm 16, since there is not required a thickness for tap holes to be formed in a wall of the arm main body 17, the wall of the arm main body 17 can be made thinner, and even greater weight-lightening can be achieved, compared to in conventional technology (for example, Japanese Laid-Open Patent Publication No. 2016-132031) where fastening members are employed. That is, in the hollow arm 16, cutting processing can be performed along the cutting line CL shown in FIG. 5E with the cutting line CL drawn in as far as possible to the inside while still leaving at least part of the joining portion J.

In the welding gun 10, the hollow arm 16 does not need disposition of fastening members such as bolts to be considered, so degree-of-freedom of design of the hollow arm 16 is high, and since fastening members such as bolts are not employed, surface finish of the hollow arm 16 can be made beautiful.

In the welding gun 10, the hollow arm 16 has its arm main body 17 and cover 19 fixed by friction stir welding, hence initial deflection can be even further suppressed to a minimum, compared to when fixing is performed by welding joining. Thus, quality of the hollow arm 16 can be improved. As a result, the high quality hollow arm 16 can be realized, and the welding gun 10 comprising such a hollow arm 16 can be realized.

Friction stir welding is accomplished with less heat input compared to welding joining, hence is less prone to distortion due to molding, and is optimal for fixing of the arm main body 17 and cover 19 of the hollow arm 16 of the welding gun 10 where there are required shape accuracy for holding the electrodes and weight-lightening.

As shown in FIGS. 2 and 3, the arm main body 17 has the base plate portion 17c that configures the first side wall 16w1, which is one of the first side wall 16w1 and the second side wall 16w2 of the hollow arm 16 that face each other. The arm main body 17 further has the peripheral wall plate portion 17d that projects in the thickness direction of the base plate portion 17c from the peripheral edge portion of the base plate portion 17c, and extends along the peripheral edge portion of the base plate portion 17c. The cover 19 configures the second side wall 16w2 of the hollow arm 16. As a result, the hollow arm 16 achieving even more weight-lightening can be realized.

As shown in FIG. 3, the opening end surface 17b of the arm main body 17 and the peripheral edge portion 19a of the cover 19 are fixed by the friction stir welding portion 30. As a result, friction stir welding can be performed in a state where the peripheral edge portion 19a of the cover 19 has been placed on the step 21a1 of the main body member 21 (the material prior to being molded in the shape of the arm main body 17), as shown in FIGS. 5C and 5D, so the arm main body 17 and the cover 19 can be easily friction stir welded.

The opening end surface 17b of the arm main body 17 and the peripheral edge portion 19a of the cover 19 are fixed by the friction stir welding portion 30 over the entire periphery. Thus, the arm main body 17 and the cover 19 can be joined with even higher strength. That is, sufficient rigidity of the hollow arm 16 can be secured even without there being reinforcement of ribs or the like, or even with reinforcement of ribs or the like being reduced to the utmost. As a result, a welding gun 10 comprising an even more light-weight and even more highly rigid hollow arm 16 can be realized.

The welding gun 10 has the housing 24 as the gripping portion to be gripped by the welding robot. As a result, the movable arm of the welding robot does not require a large physical strength, so there is no need for a large-sized welding robot to be employed.

As shown in FIGS. 4A and 5B, the method of manufacturing the hollow arm 16 that holds the movable electrode 14 includes: a step of providing the main body member 21 which is made of a metal and has the cavity portion 21a, wherein the main body member 21 is the material prior to being molded in the shape of the arm main body 17; and a step of providing the cover 19 having the peripheral edge portion 19a that follows the outer peripheral shape of the arm main body 17. The method of manufacturing the hollow arm 16 further includes: a step in which the cover 19 is attached to the main body member 21 so as to cover the opening of the cavity portion 21a (FIGS. 4B and 5C); and a step in which the main body member 21 and the cover 19 are friction stir welded (refer to FIG. 5D). Thus, the arm main body 17 and the cover 19 can be joined with high strength, without a fastening member such as a bolt being employed. As a result, a light-weight and highly rigid hollow arm 16 can be manufactured.

As shown in FIGS. 4A and 5B, the step of providing the main body member 21 includes a step of forming the stepped recess as the cavity portion 21a. In the step in which the cover 19 is attached to the main body member 21 so as to cover the opening of the cavity portion 21a, the peripheral edge portion 19a of the cover 19 is inserted in the step 21a1 of the stepped recess 21a of the main body member 21 to fit the cover 19 to the stepped recess 21a, as shown in FIGS. 4B and 5C. In the step of friction stir welding, the peripheral edge portion 19a of the cover 19 and the peripheral portion 21a2 of the step 21a1 of the main body member 21 are friction stir welded, as shown in FIGS. 5C and 5D. As a result, the peripheral edge portion 19a of the cover 19 and the peripheral portion 21a2 of the step 21a1 of the main body member 21 can be friction stir welded in a state that the peripheral edge portion 19a of the cover 19 has been placed on the step 21a1 of the main body member 21, so the hollow arm 16 can be easily manufactured.

In the method of manufacturing the hollow arm 16, in the step of providing the main body member 21, the main body member 21 is the material prior to being molded in the shape of the arm main body 17, as shown in FIG. 4B, and in the method of manufacturing the hollow arm 16, there is included, after the step of friction stir welding, a step in which the joined body 25 of the cover 19 and the main body member 21 that have been joined is processed into the shape of the hollow arm 16, as shown in FIG. 5E. It thus becomes easy for both end portions (portions other than the portion to become the arm main body 17) of the main body member 21 to be fixed at a time of friction stir welding, hence a light-weight and highly rigid hollow arm 16 can be easily manufactured.

In the step of providing the main body member 21, the main body member 21 is manufactured by forming the cavity portion 21a in the first metal plate 32a, as shown in FIGS. 5A and 5B, and in the step of providing the cover 19, there is provided the cover 19 configured from the second metal plate 32b, as shown in FIG. 4A. As a result, a thin type hollow arm 16 can be manufactured.

### MODIFIED EXAMPLES

Configuration of the above-described welding gun 10 may be appropriately altered.

Although in the above-described embodiment, the fixed electrode 12 is employed as the article held by the hollow arm 16, the present invention is not limited to this. There may be adopted a configuration where the movable electrode 14 is held by the hollow arm, and the hollow arm is moved, for example. Moreover, an article such as a tool used in industry may be held by the hollow arm, for example.

Although in the above-described embodiment, the arm main body 17 of the hollow arm 16 opens on one side in the thickness direction of the hollow arm 16, the present invention is not limited to this.

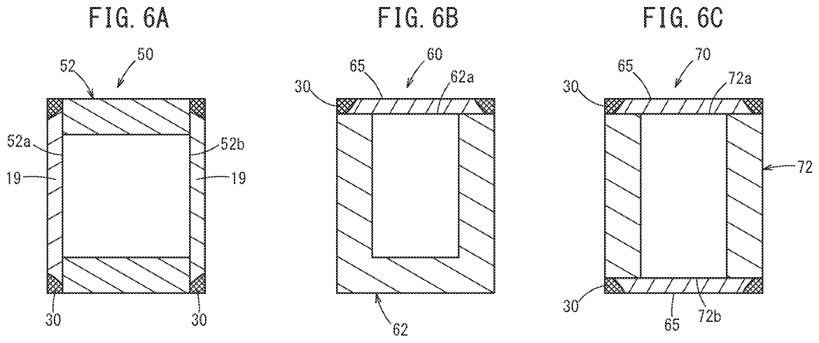

For example, an arm main body 52 may open on both sides in the thickness direction of a hollow arm 50, as in modified example 1 shown in FIG. 6A. In modified example 1, the cover 19 disposed so as to block an opening 52a on one side in the thickness direction of the arm main body 52, and the arm main body 52 are fixed by the friction stir welding portion 30. In modified example 1, the cover 19 disposed so as to block an opening 52b on another side in the thickness direction of the arm main body 52, and the arm main body 52 are fixed by the friction stir welding portion 30.

For example, an arm main body 62 may open on one side in a direction orthogonal to the thickness direction of a hollow arm 60, as in modified example 2 shown in FIG. 6B. In modified example 2, a cover 65 disposed so as to block an opening 62a on one side in the direction orthogonal to the thickness direction of the arm main body 62, and the arm main body 62 are fixed by the friction stir welding portion 30.

For example, an arm main body 72 may open on both sides in a direction orthogonal to the thickness direction of a hollow arm 70, as in modified example 3 shown in FIG. 6C. In modified example 3, the cover 65 disposed so as to block an opening 72a on one side in the thickness direction of the arm main body 72, and the arm main body 72 are fixed by the friction stir welding portion 30. In modified example 3, the cover 65 disposed so as to block an opening 72b on another side in the thickness direction of the arm main body 72, and the arm main body 72 are fixed by the friction stir welding portion 30.

### REFERENCE SIGNS LIST

10: welding gun (resistance welding device)
12: fixed electrode (electrode, article)
16, 50, 60, 70: hollow arm
17, 52, 62, 72: arm main body
17a; cavity portion
17a1: opening
17b; opening end surface of arm main body
17c; base plate portion
17d; peripheral wall plate portion
19, 65: cover
19a; peripheral edge portion of cover
21: main body member
21a; cavity portion, stepped recess
21a1: step
21a2: peripheral portion of step
24: housing (gripping portion)
30: friction stir welding portion

What is claim is:

1. A resistance welding device that welds a workpiece by electrifying the workpiece via an electrode, the resistance welding device comprising
a hollow arm configured to hold the electrode,
the hollow arm including:
an arm main body including a cavity portion that opens at least on one side; and
a cover attached to an opening end surface of the arm main body so as to cover an opening of the cavity portion, and
the arm main body and the cover being fixed by a friction stir welding portion extending along a peripheral edge portion of the cover.

2. The resistance welding device according to claim 1, wherein
the arm main body includes:
a base plate portion that configures a first side wall, which is one of the first side wall and a second side wall of the hollow arm that face each other; and
a peripheral wall plate portion that projects in a thickness direction of the base plate portion from a peripheral edge portion of the base plate portion, and extends along the peripheral edge portion of the base plate portion, and
the cover configures the second side wall of the hollow arm.

3. The resistance welding device according to claim 1, wherein
the opening end surface of the arm main body and the peripheral edge portion of the cover are fixed by the friction stir welding portion.

4. The resistance welding device according to claim 3, wherein
the opening end surface of the arm main body and the peripheral edge portion of the cover are fixed by the friction stir welding portion over an entire periphery.

5. The resistance welding device according to claim 1, wherein
the resistance welding device includes a gripping portion gripped by a welding robot.

6. A hollow arm that holds an article, the hollow arm comprising:
an arm main body including a cavity portion that opens at least on one side; and
a cover attached to an opening end surface of the arm main body so as to cover an opening of the cavity portion,
the arm main body and the cover being fixed by a friction stir welding portion extending along a peripheral edge portion of the cover.

7. The hollow arm according to claim 6, wherein
the arm main body includes:
a base plate portion that configures a first side wall, which is one of the first side wall and a second side wall of the hollow arm that face each other; and
a peripheral wall plate portion that projects in a thickness direction of the base plate portion from a peripheral edge portion of the base plate portion, and extends along the peripheral edge portion of the base plate portion, and
the cover configures the second side wall of the hollow arm.

8. The hollow arm according to claim 6, wherein
the opening end surface of the arm main body and the peripheral edge portion of the cover are fixed by the friction stir welding portion.

9. The hollow arm according to claim 8, wherein
the opening end surface of the arm main body and the peripheral edge portion of the cover are fixed by the friction stir welding portion over an entire periphery.

10. A method of manufacturing a hollow arm that holds an article, the method comprising:
a step of providing a main body member made of a metal and including a cavity portion that opens at least on one side, the main body member being an arm main body including the cavity portion or being a material prior to being molded in a shape of the arm main body;
a step of providing a cover including a peripheral edge portion that follows an outer peripheral shape of the arm main body;
a step of attaching the cover to the main body member in a manner that the cover covers an opening of the cavity portion; and
a step of friction stir welding the main body member and the cover.

11. The method of manufacturing a hollow arm according to claim 10, wherein
the step of providing the main body member includes a step of forming a stepped recess as the cavity portion,
in the step of attaching to the main body member, the peripheral edge portion of the cover is inserted in a step of the stepped recess of the main body member to fit the cover to the stepped recess, and
in the step of friction stir welding, the peripheral edge portion of the cover and a peripheral portion of the step of the main body member are friction stir welded.

12. The method of manufacturing a hollow arm according to claim 10, wherein
in the step of providing the main body member, the main body member is the material prior to being molded in the shape of the arm main body, and
the method further comprises, after the step of friction stir welding, a step of processing a joined body of the cover and the main body member that have been joined, into a shape of the hollow arm.

13. The method of manufacturing a hollow arm according to claim 10, wherein
in the step of providing the main body member, the main body member is manufactured by forming the cavity portion in a first metal plate, and
in the step of providing the cover, the cover configured from a second metal plate is provided.
